(19) United States
(12) Patent Application Publication
(10) Pub. No.: US 2007/0108051 A1
(43) Pub. Date: May 17, 2007

(54) Oxygen sensor

(75) Inventors: Futoshi Ichiyanagi, Gunma (JP); Keiji Mori, Gunma (JP); Masami Kawashima, Gunma (JP); Akira Uchikawa, Gunma (JP); Shoichi Sakai, Gunma (JP); Masao Tsukada, Gunma (JP)

Correspondence Address: SUGHRUE MION, PLLC, 2100 PENNSYLVANIA AVENUE, N.W., SUITE 800, WASHINGTON, DC, 20037, US

(73) Assignee: HITACHI, LTD.

(21) Appl. No.: 11/600,193

(22) Filed: Nov. 16, 2006

(30) Foreign Application Priority Data
Nov. 17, 2005 (JP) 2005-332860

(51) Int. Cl. G01N 27/26

(52) U.S. Cl. 204/424

(57) ABSTRACT

In an oxygen sensor, a basic body is provided and a plurality of function layers are laminated on a surface of the basic body, the function layers including at least a solid electrolyte layer having an oxygen ion conductivity and a pair of electrode layers between which the solid electrolyte layer is inserted, a firing being carried out after the function layers are laminated on the surface of the basic body and, during the firing, a sintering of the basic body and the function layers being sequentially progressed toward an outer surface of the function layers from the basic body.

### BACKGROUND OF THE INVENTION

1. Field of the Invention

The present invention relates to an oxygen sensor.

2. Description of the Related Art

Various types of oxygen sensors have been proposed. A (laid open) Japanese Paten Application First Publication (tokkai) No. 8-114571 published on May 7, 1996 exemplifies a previously proposed oxygen sensor.

In the oxygen sensor disclosed in the above-identified Japanese Patent Application First Publication, a heater pattern formed on a basic body is power supplied and heated so that a solid electrolyte layer having an oxygen ion conductivity is activated and an oxygen concentration is detected from a potential difference between a pair of electrodes arranged to oppose with each other via the solid electrolyte layer.

In suck a kind of oxygen sensors as described above, a detection element is, in general, laminated in a multilayer form as function layers such as the solid electrolyte layer, electrode layers, an insulating layer, and protective layers and is formed by firing (or called, burning) the laminated function layers.

### SUMMARY OF THE INVENTION

However, in the previously proposed oxygen sensor described in the BACKGROUND OF THE INVENTION, according to the setting of a material of each layer included within the function layers, during the firing, there is often the case where the sintering is progressed from an outside layer (outer surface of the detection element) during the firing.

In this case, in the above-described previously proposed oxygen sensor, a stress is resided within the layer(s) at an internal side (a basic body side), an coupling state between each layer becomes unstable and cracks would probably be developed within each layer of the function layers.

It is hence an object of the present invention to provide an oxygen sensor and its manufacturing method therefor which are capable of suppressing a development in an internal residual stress of the detection element along with the firing.

In order to achieve the above-described object, according to one aspect of the present invention, there is provided an oxygen sensor, comprising: a basic body; and a plurality of function layers laminated on a surface of the basic body, the function layers including at least a solid electrolyte layer having an oxygen ion conductivity and a pair of electrode layers between which the solid electrolyte layer is inserted, a firing being carried out after the function layers are laminated on the surface of the basic body and, during the firing, a sintering of the basic body and the function layers being sequentially progressed toward an outer surface of the function layers from the basic body.

In order to achieve the above-described object, according to another aspect of the present invention, there is provided a manufacturing method for an oxygen sensor, comprising: providing a basic body; providing a plurality of function layers laminated on a surface of the basic body, the function layers including at least a solid electrolyte layer having an oxygen ion conductivity and a pair of electrode layers between which the solid electrolyte layer is inserted; and carrying out a firing after the function layers are laminated on the surface of the basic body, during the firing, a sintering of the basic body and the function layers being sequentially progressed toward an outer surface of the function layers from the basic body.

This summary of the invention does not necessarily describe all necessary features so that the present invention may also be a sub-combination of these described features.

### BRIEF DESCRIPTION OF THE DRAWINGS

FIG. 1 is a cross sectional view cut away along an axial direction of an oxygen sensor in a preferred embodiment according to the present invention.

FIG. 2 is a cross sectional view of a detection element of the oxygen sensor shown in FIG. 1 cut away along a line A-A in FIG. 1.

FIG. 3 is a characteristic graph representing a correlation between a temperature (° C.: lateral axis) and a volumetric shrinkage (%: longitudinal axis) among a core rod, a solid electrolyte layer, and a dense layer during a firing for the detection element of the oxygen sensor in the embodiment shown in FIGS. 1 and 2.

### DETAILED DESCRIPTION OF THE INVENTION

Reference will hereinafter be made to the drawings in order to facilitate a better understanding of the present invention. An embodiment of an oxygen sensor according to the present invention is applicable to an oxygen sensor used for a detection of an air-fuel ratio and is equipped within an exhaust tube of an automotive vehicle equipped with an internal combustion engine.

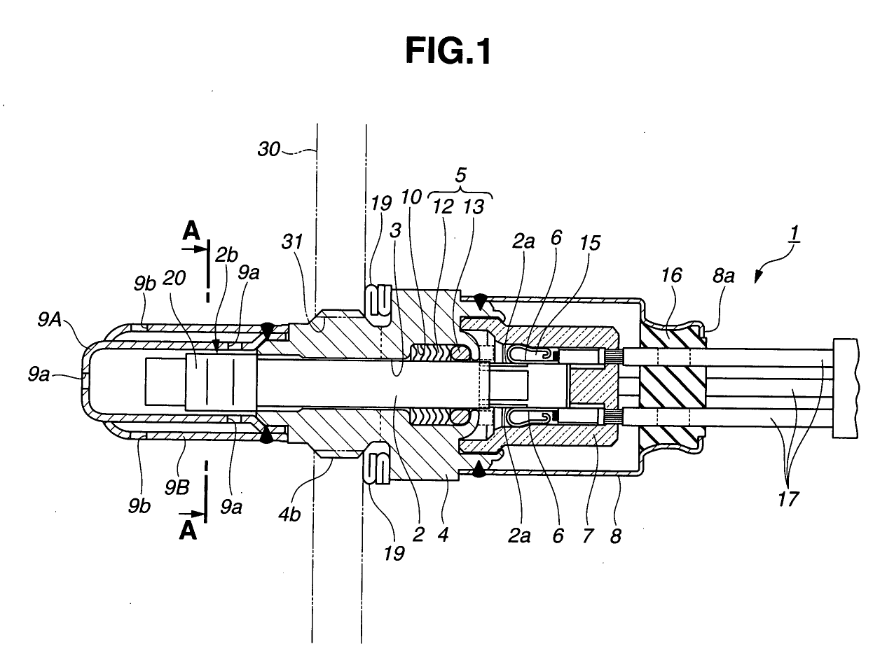

A rough configuration of the oxygen sensor in the preferred embodiment according to the present invention will be explained hereinbelow. FIG. 1 shows a cross sectional view of the oxygen sensor in the preferred embodiment (cross sectional view cut away along an axial direction of the oxygen sensor).

A cylindrical element inserting hole 3 is formed in a holder 4 and a cylindrical rod shaped detection element 2 is fitted and inserted into this element inserting hole 3. Detection element 2 is penetrated through element inserting hole 3 and is exposed from both end surfaces of the axial direction of holder 4. An oxygen measurement section 2b is formed at one end side of the axial direction of holder 4 and an electrode 2a is formed at the other end side of the axial direction of holder 4.

Oxygen measurement section 2b is inserted within double (inside and outside) protectors 9A, 9B of a double tubular structure and a cylindrically shaped structure fixed to holder 4 by means of a welding or caulking. Circulation holes 9a, 9b (circular holes) for gas circulation purposes are formed on inner side or outer side protectors 9A, 9B. Detection gas is invaded within double protector 9A, 9B via circulation holes 9a, 9b and arrives at a surrounding of oxygen measurement section 2b.

On the other hand, a diameter expanded section 10 is formed in the proximity to electrode 2a of element inserting hole 3. Thus, a seal section 5 installed on the diameter expanded section 10 serves to maintain an air-tightness at a clearance between element inserting hole 3 and detection element 2. Specifically, ceramics powder 12 (for example, an un-sintered (not sintered) talc and so forth) is filled in diameter expanded section 10 and is pressed toward a depth side of seal section 5 using a spacer 13 (for example, a washer) in order for a clearance between element inserting hole 3 and detection element 2 to be filled up.

An insulator 7 in a bell shaped (bottomed) cylindrical form for a terminal maintenance is fixed to electrode 2a of detection element 2. A cylindrical casing 8 is installed to cover an outer periphery of insulator 7 with a predetermined gap. This casing 8 is fixed on an outer periphery of holder 4 by means of a whole peripheral laser welding. This laser welding causes the air-tightness in the clearance between casing 8 and holder 4 to be secured.

In addition, an approximately cylindrical seal rubber 16 is housed at a terminal section opposite to oxygen measurement section 2b of casing 8. A plurality of (for example, four) lead wires 17 are penetrated through this seal rubber 16 and exposed externally. This seal rubber 16 is fixed to casing 8 by means of caulked section 8a between casing 8 and this seal rubber 16. The air-tightness between seal rubber 16 and lead wires 17 and between seal rubber 16 and casing 8 can be secured. It is noted that, for example, the use of fluorine-contained rubber or material having a high thermal resistance characteristic for seal rubber is preferable.

Terminals 6 are connected to an inner side terminal of each lead wire 17. These terminals 6 are held on terminal holding insulator 7. Each of terminals 6 is constituted by an elastic body. A high modulus of elasticity of each of terminals 6 causes assured contacts of corresponding terminals 6 with respective electrodes 2a formed on the surface of detection element 2 and achieves a more assured electrical conduction at this part.

The structure of whole oxygen sensor 1 has been described above. Oxygen sensor 1 is fixed to an exhaust (gas) tube 30 by inserting screw section 4b of holder 4 into screw holes 31 of exhaust tube 30 and is arranged with a section enclosed by double protectors 9A, 9B projected within exhaust tube 30. A gasket 19 is used to seal between oxygen sensor 1 and exhaust tube 30.

An internal space 15 formed within an inside of oxygen sensor 1 is fixed to exhaust tube 30 by inserting junction parts between seal section 5, seal rubber 16, and a junction part between holder 4 and casing 8. The air-tightness is secured against an external of oxygen sensor 1. It is noted that an extremely minute clearance (for example, a gap between a core wire and a coating) in an internal of lead wires 17 provides a communication with an external side of oxygen sensor 1.

When, in oxygen sensor 1 described above, detection gas flowing within exhaust tube 30 is caused to flow into an inside of oxygen sensor 1 through circulation holes 9a, 9b of double protectors 9A, 9B, oxygen within the detection gas is caused to flow within oxygen measurement section 2b. At this time, an oxygen concentration of detection gas is detected by means of the oxygen measurement section 2b and converts the concentration of oxygen into an electrical signal representing the oxygen concentration. Then, an information on this electrical signal is outputted externally via electrodes 2a, terminals 6, and lead wires 17.

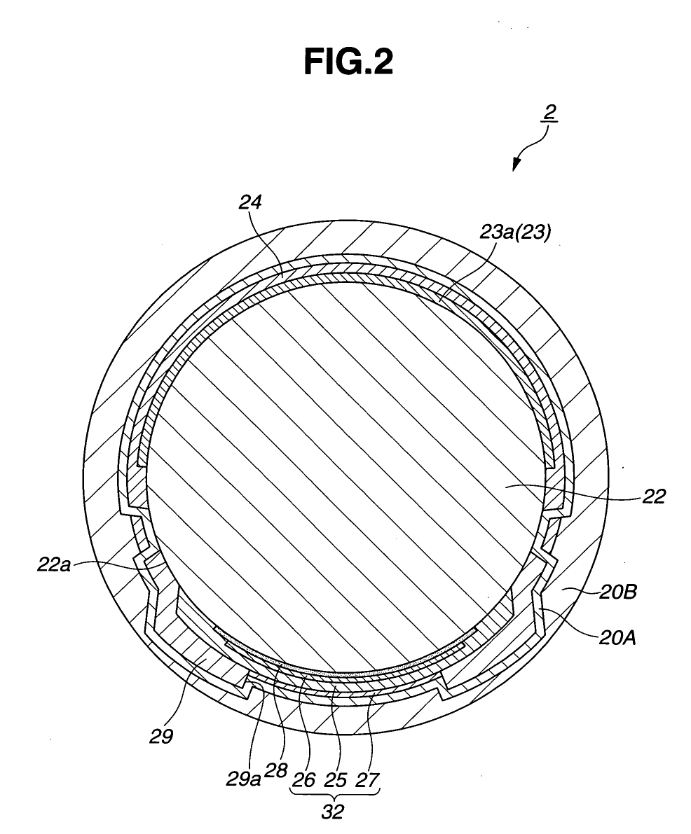

Next, a structure of oxygen measurement section 2b will be described below. FIG. 2 shows a lateral cross sectional view of detection element 2 (a cross sectional view cut away along a line A-A in FIG. 1).

Detection element 2 approximately includes: a core rod 22 as a basic body; a heater pattern 23 as a heater layer formed on a predetermined region (a region over an approximately half periphery) of an outer peripheral surface of this core rod 22; a heater insulated layer 24 covering this heater pattern 23; a solid electrolyte layer 25 having an oxygen ion conductivity formed at a position opposite to heater pattern 23 on outer peripheral surface 22a of core rod 22; an inner electrode (reference electrode) 26 as an electrode layer formed at an inner surface of solid electrolyte layer 25; an outer electrode (detection electrode) 26 as an electrode layer formed on an outer surface of solid electrolyte layer 25; a relaxation layer 28 installed between an inner surface of solid electrolyte layer 25 and an outer surface of outer electrode 27; a dense layer 29 formed on the outer surfaces of solid electrolyte layer 25 and outer electrode 27; a print protective layer 20A wholly covering the outer surface of heater insulating layer 24; and spinel protective layer 20B covering a region of the whole outer surface of print protective layer 20A.

Detection element 2 is formed by laminating each layer of the function layers (heater pattern 23, heater insulating layer 24, solid electrolyte layer 25, inner (the one) electrode 26, outer (the other) electrode 27, relaxation layer 28, dense layer 29, a print protective layer 20A, and a spinel protective layer 20B on core rod 22 and, thereafter, firing (burning) these function layers and core rod 22.

Core rod 22 is formed in a cylindrical shape having a solid or hollow section by means of a ceramics material such as alumina which is an insulating material.

Heater pattern 23 is formed of a heat generative conductive material such as tungsten or platinum. This heater pattern 23 is electrically connected with two of four lead wires 17 (refer to FIG. 1). An external power supply supplies an electrical power for a heater pattern 23 via these lead wires 17 so that, particularly, heater section 23a generates the heat from heater pattern 23 so that a temperature of solid electrolyte layer 25 is raised and is activated.

Heater insulating layer 24 is formed of an insulating material and secures the electrical insulation of heater pattern 23.

Solid electrolyte layer 25 is formed, for example, by mixing a powder of yttria of a predetermined weight % with a powder of zirconia to make a paste form and is formed by patterning the paste formed powder and firing it. Solid electrolyte layer 25 generates an electromotive force according to a surrounding oxygen concentration difference between inner electrode 26 and outer electrode 27 and transports oxygen ion in its thickness direction of solid electrolyte layer 25.

Then, these solid electrolyte layer 25, inner electrode 26, and outer electrode layer 27 constitute an oxygen concentration detection section 32 to produce the oxygen concentration in a form of electrical signal. It is noted that both of oxygen concentration detection section 32 and heater pattern 23 are spaced apart with a positional deviation in a circumference direction of core rod 22. In this embodiment, these are arranged at positions mutually opposite with each other via core rod 22.

Each of inner electrode 26 and outer electrode 27 has an electrical conductivity and formed with a metallic material (for example, platinum) through which oxygen can be transmitted. Two of four lead wires 17 (refer to FIG. 1) are respectively connected with inner electrode 26 and outer electrode 27. An output voltage developed between inner electrode 26 and outer electrode 27 can be detected as a voltage across these lead wires 17.

Furthermore, in the embodiment, inner electrode 26 is patterned with mixture and addition of a hole forming agent such as theobromine to a precious metal (for example, platinum), mixed together, and is formed by firing the patterned mixture. As described above, if the hole forming agent is mixed and formed in this way, the hole forming agent (dissipation agent) is annealed and blown off so that the hole is formed within each of the electrodes so that each electrode (layer) can provide a porous structure.

In addition, relaxation layer 28 is formed by patterning a mixing material between zirconia and aluminum with the addition of a hole forming agent (dissipation agent) such as carbon and is formed by firing the patterned mixture described above to provide a porous structure. Hence, oxygen introduced to inner electrode 26 through solid electrolyte layer 25 can be invaded into relaxation layer 28.

Dense layer 29 is formed of a ceramics material such as alumina, the material through which oxygen in detection gas cannot be transmitted. Dense layer 29 coats the outer surface of solid electrolyte layer 25 except an electrode window part (not shown).

Print protective layer 20A covers dense layer 29 and whole surface outside heater insulating layer 24. In addition, print protective layer 20A does not transmit a poisonous gas and dust in a detection gas. However, print protective layer 20A is formed of a material quality through which oxygen in the detection gas can be transmitted, for example, of the porous material of a mixture of alumina and magnesium oxide.

Spinel protective layer 20B covers the whole surface of the outside of detection element 2, can transmit oxygen in the detection gas, and is formed of the porous material which is coarser than print protective layer 20A.

Oxygen sensor 1, in this embodiment, is configured to sequentially progress the sintering of core rod 22 as the basic body and the function layers toward the outer surface (namely, spinel protective layer) of the function layers from core rod 22. Along with a thermal shrinkage during the firing, oxygen sensor 1 can suppress a development in the internal residual stress.

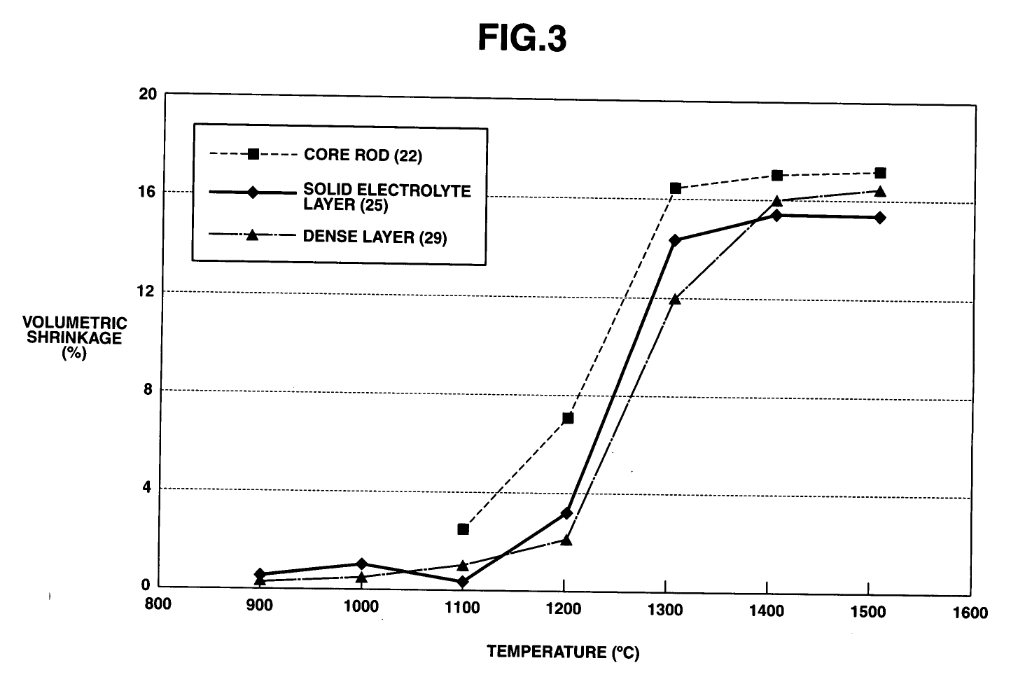

FIG. 3 shows an example of a sintering characteristic of each part of detection element 2, namely, a plotted diagram representing a correlation between the temperature (° C.: lateral axis) and a volumetric shrinkage (%: longitudinal axis) on core rod 22, solid electrolyte layer 25, and dense layer 29 during the firing. As shown in FIG. 3, in this embodiment, a sequential sintering in a sequence of core rod 22, solid electrolyte layer 25, and dense layer 29 is started and completed and it will be understood that, as described above, core rod 22 is positioned at a most inner part and on which solid electrolyte layer 25 and dense layer 29 are arranged in this sequence toward an outside of detection element 2 (namely, an outer surface of the function layers and, in more details, toward the spinel protective layer 20B). In other words, in this embodiment, a sintering speed is made faster as the position becomes inner side and the sintering speed is made slower as the position becomes outer side so that the sequential sintering is progressed from the inner side toward the outer side. Thus, the development in the internal residual stress in detection element 2 is suppressed. It is noted that, in FIG. 3, the sintering characteristic only for the three layer positions is indicated. However, the same can be applied to the other layer positions. It is preferable for the sequential sintering from the inner side to the outer side to be progressed.

In this case, a temperature by which core rod 22 and each layer within the function layers during the firing are shrank to the volumetric shrinkage (in the example of FIG. 3, about 8%) which is about half of those in a sintering completion state (in the example of FIG. 3, a state in which the volumetric shrinkage is about 15% through about 16%) (in the example of FIG. 3, about 8%) is set in order for the temperature to be sequentially progressed from core rod 22 (inner side) to the surface side (outer side) of the function layers. As a region in which the temperature of the inner layer corresponding to the volumetric shrinkage is lower than the temperature of the outer layer corresponding to the above-described shrinkage (a region of about 3% to about 14% in the volumetric shrinkage) becomes wider, a more favorable characteristic is indicated. However, for the whole process from the start of firing to the completion of the sintering, it is not essential for the temperature of the inner layer to become low.

Then, in this way, for detection element 2, a characteristic such that the sintering speed of core rod 22 (inner side) for detection element 2 is made faster than the sintering speed at the surface side (outer side) of the function layers can be obtained by appropriately adjusting, for each of core rod 22 and the function layers, the component of the material powder therefor (each of core rod 22 and the function layers), a particle diameter of the material powder therefor, and a specific surface area (a surface area per unit weight) of the material powder therefor, or contents of the sintering additive (sintering aid) therefor.

That is to say, it is obvious, for components of the material powder, that the sintering speed for each layer can be varied using the material powders substantially mutually different sintering characteristics. In addition, for the specific surface area of the material powder, as the specific surface area becomes larger, the sintering speed can be fastened. For the particle diameter of the material powder, as the particle diameter becomes larger, the sintering speed can be slowed. In addition, for the contents of a sintering additive, the sintering is promoted as the contents thereof becomes increased. The sintering speed can become faster.

In addition, in this embodiment, the sintering of core rod 22 and the function layers can be completed at a temperature ranging from 1300° C. to 1600° C., these temperature value being higher than the conventional sintering thereof. Thus, each layer of the function layers can more be stabilized and the more accurate fixation of any one of the function layers to the other layers can be achieved.

In addition, it was determined according to the inventors' detailed discussion and experiments that, when a film thickness of the function layers was 10% or thinner than the diameter of core rod 22, a difference between a shrinkage of the function layers on core rod 22 (inner side) and the shrinkage of any of the function layers at the outer surface side could appropriately be suppressed and the development of a peeling on a boundary section between core rod 22 and the function layers could be suppressed.

In the way as described above, in this embodiment, the sintering of core rod 22 (inner side) as the basic body and the function layers is progressed sequentially from core rod 22 to the outer surface of the function layers. Hence, the development of the internal residual stress along with the thermal shrinkage during the firing can be suppressed.

In addition, in this embodiment, the temperature at which core rod 22 and each of the function layers are shrank to the respective predetermined shrinkages which are about half of those in their sintering completion states is sequentially increased from core rod 22 toward the outer surface of the function layers. The sintering of core rod 22 and the function layers is sequentially progressed from core rod 22 toward the outer surface of the function layers. Hence, the development of the internal residual stress along with the thermal shrinkage during the firing can be suppressed.

According to the preferred embodiment, the temperature at which core rod 22 and the function layers are shrank to the predetermined shrinkages which are about half of those in the sintering completion state is sequentially progressed toward a surface side of the function layers from core rod 22, the development in the internal residual stress along with the thermal stress during the firing can be suppressed.

In addition, according to this embodiment, for core rod 22 and each of the function layers, at least one of components of the material powder, the particle diameter of the material powder, the specific surface area of the material powder is made different to adjust the sintering speed of core rod 22 and each layer within the function layers. Thus, a residue of the internal stress along with the thermal shrinkage during the firing can be suppressed.

In addition, according to the present invention, core rod 22 is formed in the rod shape. Thus, oxygen sensor 1 can be compacted.

In addition, according to this embodiment, core rod 22 as the basic body and the function layers can be sintered at a temperature ranging from 1300° C. to 1600° C. which is higher than a conventional temperature value, since the internal residual stress can be suppressed. Hence, each layer can more stably be fixed with each other to core rod 22.

In addition, according to the preferred embodiment, the film thickness of the function layers is equal to 10% or below the diameter of core rod 22. Hence, this can suppress the development of the peeling at the boundary between core rod 22 and the function layers due to an enlarged difference in the shrinkage (shrinkage quantity) of the function layers between core rod 22 and the surface side of the function layers.

In addition, according to the preferred embodiment, solid electrolyte layer 25 and heater pattern 23 are shifted in a circumference direction of core rod 22 and spaced apart from each other. Thus, an abrupt rise in the temperature of solid electrolyte layer 25 due to the heat of heater pattern 23 and excessive heat of solid electrolyte layer 25 can be suppressed.

Although the invention has been described above by reference to certain embodiment of the present invention, the invention is not limited to the embodiment described above. Modifications and variations of the embodiments described above will occur to those skilled in the art in light of the above teachings. For example, the ceramics layer of the detection element or the other layers of the detection element may be formed using materials, components, or manufacturing methods other than those described in the above embodiment. In addition, the shape, the material quality, and the manufacturing method other than the detection element may appropriately adopt other embodiments. Since, according to the present invention, an oxygen sensor comprises: a basic body; and a plurality of function layers laminated on a surface of the basic body, the function layers including at least a solid electrolyte layer having an oxygen ion conductivity and a pair of electrode layers between which the solid electrolyte layer is inserted, a firing being carried out after the function layers are laminated on the surface of the basic body and, during the firing, a sintering of the basic body and the function layers being sequentially progressed toward an outer surface of the function layers from the basic body, the development in the internal residue stress along with the thermal shrinkage during the firing can be suppressed.

This application is based on a prior Japanese Patent Applications No. 2005-332860 filed in Japan on Nov. 17, 2005, the disclosures of the Japanese Patent Applications being hereby incorporated by reference.

The scope of the invention is defined with reference to the following claims.

1. An oxygen sensor, comprising:
a basic body; and
a plurality of function layers laminated on a surface of the basic body, the function layers including at least a solid electrolyte layer having an oxygen ion conductivity and a pair of electrode layers between which the solid electrolyte layer is inserted, a firing being carried out after the function layers are laminated on the surface of the basic body and, during the firing, a sintering of the basic body and the function layers being sequentially progressed toward an outer surface of the function layers from the basic body.

2. The oxygen sensor as claimed in claim 1, wherein a temperature at which the basic body and each of the function layers are shrank to predetermined shrinkages which are approximately half of those in their sintering completion states, respectively, becomes sequentially higher from the basic body toward the outer surface of the function layers.

3. The oxygen sensor as claimed in claim 1, wherein at least any one of components of a material powder for each of the basic body and the function layers, a particle diameter of the material powder therefor, and a specific surface area of the material powder therefor, and contents of a sintering additive to the material powder therefor is made different in order for the sintering of the basic body and function layers to sequentially be progressed from the basic body toward the outer surface of the function layers.

4. The oxygen sensor as claimed in claim 1, wherein the basic body is formed in a rod shape.

5. The oxygen sensor as claimed in claim 1, wherein the function layer further comprises a heater layer, an insulating layer, and a dense layer configured to coat any layer of the function layers.

6. The oxygen sensor as claimed in claim 1, wherein the basic body and the function layers are sintered at a temperature ranging from 1300° C. to 1600° C.

7. The oxygen sensor as claimed in claim 1, wherein a film thickness of the whole function layers is 10% or thinner than a diameter of the basic body.

8. The oxygen sensor as claimed in claim 4, wherein both of the solid electrolyte layer and the heater layer are spaced apart from each other.

9. The oxygen sensor as claimed in claim 4, wherein the basic body is a core rod in a solid cylindrical shape and which is made of an insulating material.

10. The oxygen sensor as claimed in claim 9, wherein the core rod is made of alumina.

11. The oxygen sensor as claimed in claim 9, wherein the function layers comprises: a heater layer formed on a predetermined region of an outer peripheral surface of the core rod; a heater insulating layer formed to cover the heater layer; the solid electrolyte layer formed at a position of the outer peripheral surface of the core rod opposite to the heater layer, the pair of electrode layers, one of the pair of electrode layers being formed on an inner surface of the solid electrolyte layer and the other electrode layer being formed on an outer surface of the solid electrolyte layer; a relaxation layer interposed between an inner surface of the one electrode and an outer surface of the electrolyte layer; a dense layer formed on the solid electrolyte layer; a dense layer formed on the solid electrolyte layer and an outer surface of the other electrode layer; a printed protective layer formed to cover outer surfaces of the wholly dense layer and heater insulating layer; and a spinel protective layer to cover a whole region of the outer surface of the print protective layer.

12. The oxygen sensor as claimed in claim 11, wherein the core rod and the function layers constitute a detection element of the oxygen sensor, the detection element being formed by a lamination of each layer of the function layers on the core rod and, thereafter, the firing is carried out and being exposed in an exhaust passage of an internal combustion engine to detect an air-fuel ratio.

13. The oxygen sensor as claimed in claim 11, wherein the heater layer is made of a heat generating conductive material selected from one of tungsten and platinum.

14. The oxygen sensor as claimed in claim 11, wherein the solid electrolyte layer is formed by mixing a powder of yttria having a predetermined weight % in the powder of zirconia to produce a paste form mixture, patterning the paste mixture, and firing the patterned mixture, the solid electrolyte layer generating an electromotive force according to a surrounding oxygen concentration difference between the pair of electrode layers and transporting oxygen ion in its thickness direction.

15. The oxygen sensor as claimed in claim 11, wherein the other electrode is formed by adding a hole forming agent to a precious metal material, patterning a mixture of the precious metal within the hole forming agent, and firing the patterned mixture.

16. The oxygen sensor as claimed in claim 11, wherein the dense layer is made of a material through which oxygen cannot be transmitted.

17. A manufacturing method for an oxygen sensor, comprising:
providing a basic body;
providing a plurality of function layers laminated on a surface of the basic body, the function layers including at least a solid electrolyte layer having an oxygen ion conductivity and a pair of electrode layers between which the solid electrolyte layer is inserted; and
carrying out a firing after the function layers are laminated on the surface of the basic body, during the firing, a sintering of the basic body and the function layers being sequentially progressed toward an outer surface of the function layers from the basic body.

18. The manufacturing method of the oxygen sensor as claimed in claim 17, wherein a temperature at which the basic body and each layer of the function layers are shrank to predetermined shrinkages which are approximately half of those in their sintering completion states, respectively, becomes sequentially higher from the basic body toward the outer surface of the function layers.

19. The manufacturing method for the oxygen sensor as claimed in claim 17, wherein at least any one of components of a material powder for each of the basic body and the function layers, a particle diameter of the material powder therefor, and a specific surface area of the material powder therefor, and contents of a sintering additive to the material powder therefor is made different in order for the sintering of the basic body and function layers to sequentially be progressed from the basic body toward the outer surface of the function layers.

20. The manufacturing method for the oxygen sensor as claimed in claim 17, wherein the basic body and the function layers are sintered at a temperature ranging from 1300° C. to 1600° C.
